(19) United States
(12) Patent Application Publication
(10) Pub. No.: US 2002/0063925 A1
(43) Pub. Date: May 30, 2002

(54) Broadcast type optical network system using loop shaped optical networks

(76) Inventors: Tomohiro Otani, Suitama-ken (JP); Yukio Horiuchi, Saitama-ken (JP); Shu Yamamoto, Tokyo (JP); Keizou Kitahara, Chiba-ken (JP); Atsushi Arai, Tokyo (JP); Mikio Yokoyama, Tokyo (JP)

Correspondence Address: OLSON & HIERL, LTD., 36th Floor, 20 North Wacker Drive, Chicago, IL, 60606, US

(21) Appl. No.: 09/878,114

(22) Filed: Jun. 8, 2001

(30) Foreign Application Priority Data
Jun. 8, 2000 (JP) 2000-171833

(51) Int. Cl. H04J 14/02; H04B 10/00

(52) U.S. Cl. 359/125; 359/167

(57) ABSTRACT

A network system capable of delivering a large amount of data such as video data freely according to the intentions of the sender and the receiver alone is realized by a plurality of stations provided on at least one loop shaped optical network in which any one of the plurality of stations is capable of carrying out unidirectional communications with respect to any other one of the plurality of stations, where at least one wavelength is allocated to each station such that each station can transmit data by using a wavelength allocated to each station, receive data of any wavelengths transmitted from any other stations, and select only necessary wavelengths so as to select correspondent stations from which data are to be received.

### BACKGROUND OF THE INVENTION

1. Field of the Invention

The present invention relates to a broadcast type optical network system.

2. Description of the Related Art

In order to realize the nationwide delivery of video data, the current video transmission network utilizes a scheme for temporarily allocating ATM (Asynchronous Transfer Mode) switches or dedicated lines because of the enormous amount of data required, and allocations with respect to calls originating arbitrarily throughout the nation are realized through the manual scheduling by network managers.

Such a conventional video data delivery scheme has been associated with inconvenience and tediousness related to the impossibility of carrying out communications freely at arbitrary time zone according to the intentions of the sender and the receiver alone.

### BRIEF SUMMARY OF THE INVENTION

It is therefore an object of the present invention to provide a network system capable of delivering a large amount of data such as video data freely according to the intentions of the sender and the receiver alone.

According to one aspect of the present invention there is provided a broadcast type optical network system, comprising: at least one loop shaped optical network; and a plurality of stations provided on the at least one loop shaped optical network; wherein at least one wavelength is allocated to each station such that each station can transmit data by using a wavelength allocated to said each station, receive data of any wavelengths transmitted from any other stations, and select only necessary wavelengths so as to select correspondent stations from which data are to be received, and each station has a function for loading or re-loading wavelengths, and a function for discarding signals of one wavelength transmitted from said each station that has circulated through the at least one loop shaped network in order to prevent multiple circulations of the signals of said one wavelength; such that any one of the plurality of stations is capable of carrying out unidirectional communications with respect to any other one of the plurality of stations.

Other features and advantages of the present invention will become apparent from the following description taken in conjunction with the accompanying drawings.

### BRIEF DESCRIPTION OF THE DRAWINGS

FIG. 1 is a diagram showing a configuration of a broadcast type optical network system according to the the present invention.

FIG. 2 is a diagram showing a relationship between a connection node and an accommodation node in the network system of FIG. 1.

FIG. 3 is a block diagram showing a configuration of a connection node in the first embodiment of the present invention.

FIG. 4 is a block diagram showing a configuration of an accommodation node in the first embodiment of the present invention.

FIG. 5 is a block diagram showing a configuration of a dependent station in the first embodiment of the present invention.

FIG. 6 is a block diagram showing a configuration of an independent station in the first embodiment of the present invention.

FIG. 7 is a block diagram showing a configuration of a connection node in the second embodiment of the present invention.

FIG. 8 is a block diagram showing a configuration of an accommodation node in the second embodiment of the present invention.

FIG. 9 is a block diagram showing a configuration of a connection node and an independent station in the third embodiment of the present invention.

FIG. 10 is a block diagram showing a configuration of a connection node in the fourth embodiment of the present invention.

FIG. 11 is a block diagram showing a configuration of an accommodation node in the fourth embodiment of the present invention.

FIG. 12 is a diagram showing a relationship between dedicated wavelengths used in a sub-loop and transmission wavelengths used in a main loop according to the fourth embodiment of the present invention.

FIG. 13 is a diagram showing a configuration of a parent station in the fifth embodiment of the present invention.

### DETAILED DESCRIPTION OF THE INVENTION

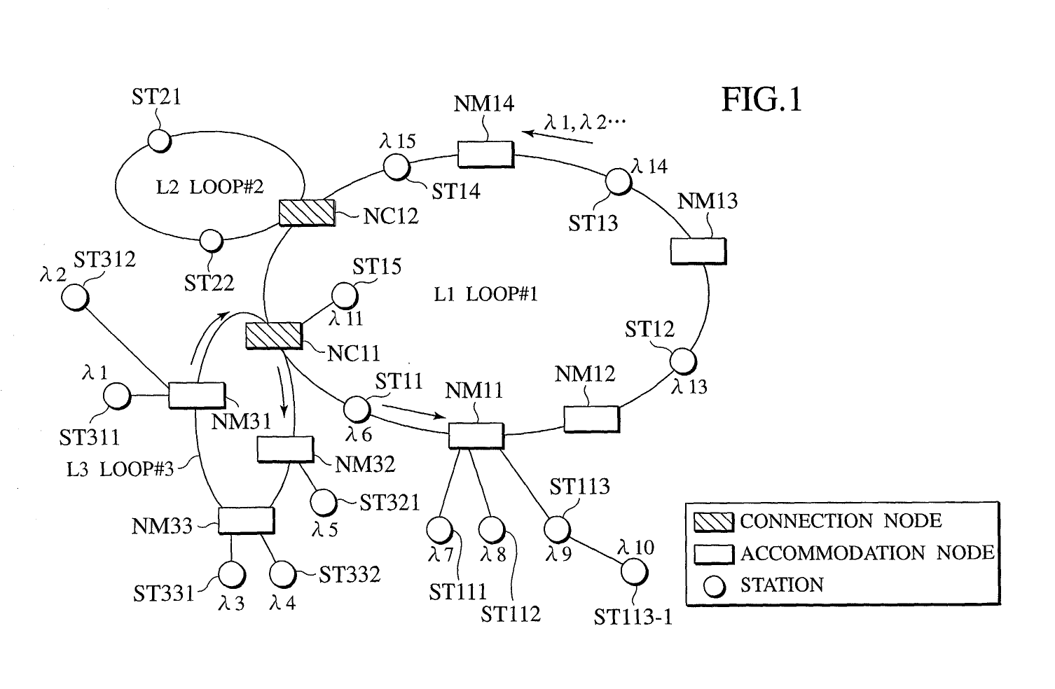

Referring now to FIG. 1 to FIG. 13, several embodiments of a broadcast type optical network system according to the present invention will be described in detail.

FIG. 1 shows an exemplary system configuration according to the first embodiment of the present invention. The broadcast type optical network system of this embodiment comprises a network L1 that constitutes a main loop #1, and networks L2 and L3 that constitute sub-loops #2 and #3. Each loop L1, L2, . . . is provided with stations ST11, ST12, . . . for transmitting data, connection nodes NC 11, NC12, . . . for connecting neighboring network loops, and accommodation nodes NM11, NM12, . . . for accommodating one or a plurality of stations.

The stations ST11, ST12, . . . are allocated with mutually different wavelengths λ1, λ2, . . . respectively.

Also, the connection nodes NC11, NC12, . . . and the accommodation nodes NM11, NM12, . . . have the following functions.

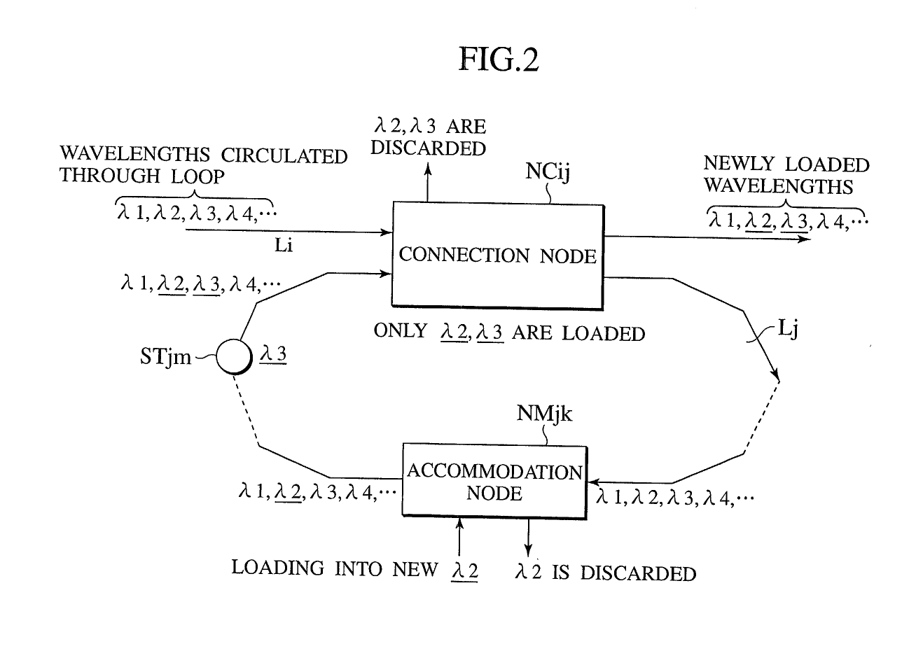

Namely, as shown in FIG. 2, there are a main loop network Li and a neighboring sub-loop network Lj, and suppose that the sub-loop network Lj has a station STjm to which a wavelength λ3 is allocated and an accommodation node NMjk, and a station to which a wavelength λ2 is allocated is connected to this accommodation node NMjk.

In such a system, the connection node NCij receives all the wavelengths λ1, λ2, λ3, λ4, λ5, λ6, . . . that have circulated through the main loop Li and circulates them through the sub-loop network Lj as well.

Then, at the accommodation node NMjk, the wavelength λ2 of the station accommodated in the own node is discarded from the wavelengths λ1, λ2, λ3, λ4, λ5, λ6, . . . circulating on the network, and data are loaded onto the wavelength λ2 that is newly sent from the station (hereafter, the wavelength onto which data are newly loaded will be indicated by attaching the underline). Also, the station STjm loads new data onto the wavelength λ3 allocated to the own station and sends it out.

At the connection node NCij, when signals of the wavelengths λ1, λ2, λ3, λ4, λ5, λ6, . . . circulated through the sub-loop Lj are received from there, the wavelengths λ2 and λ3 that became obsolete are discarded from the wavelengths λ1, λ2, λ3, λ4, λ5, λ6, . . . on the main loop Li that have been maintained until then, the wavelengths λ2 and λ3 that have been updated during the circulation through the sub-loop Lj are loaded, and newly loaded wavelengths λ1, λ2, λ3, λ4, λ5, λ6 are sent out to the main loop Li.

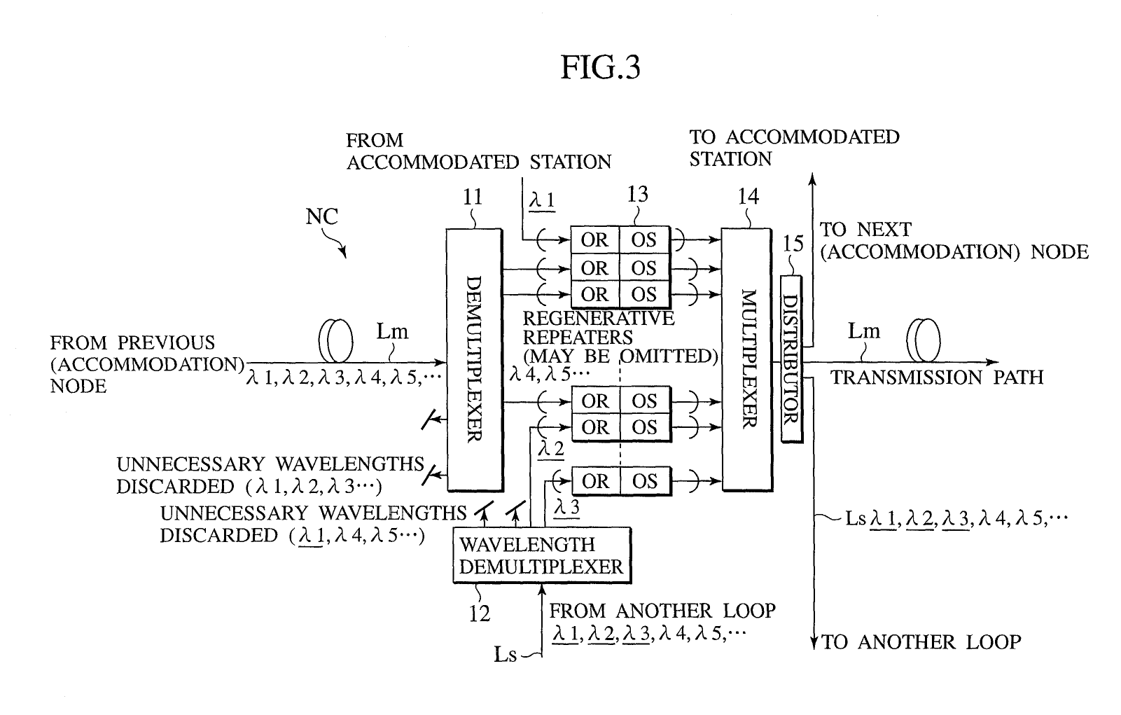

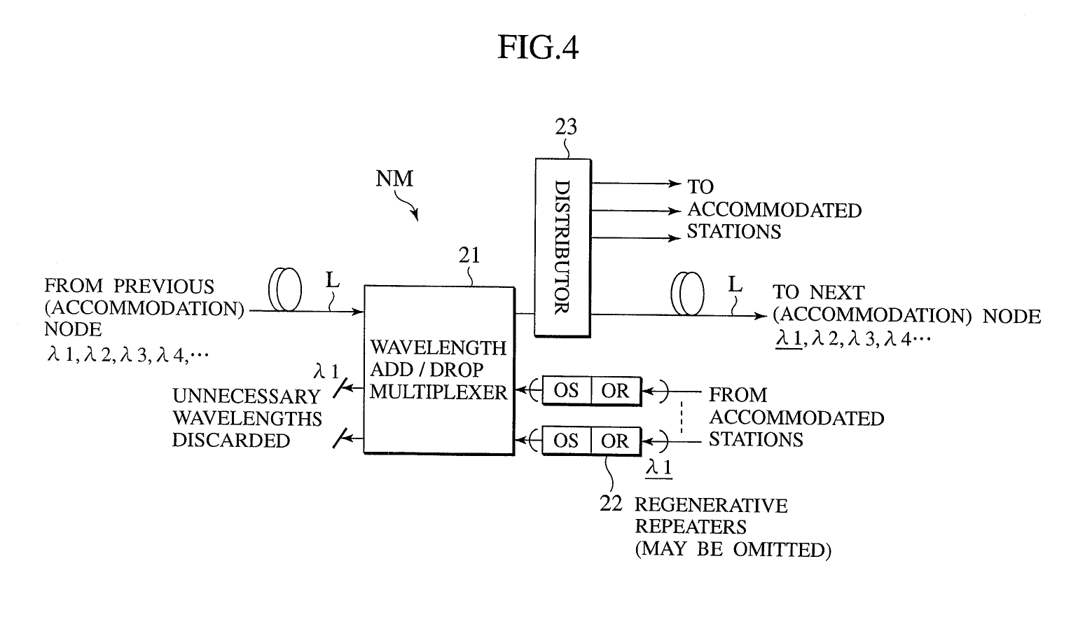

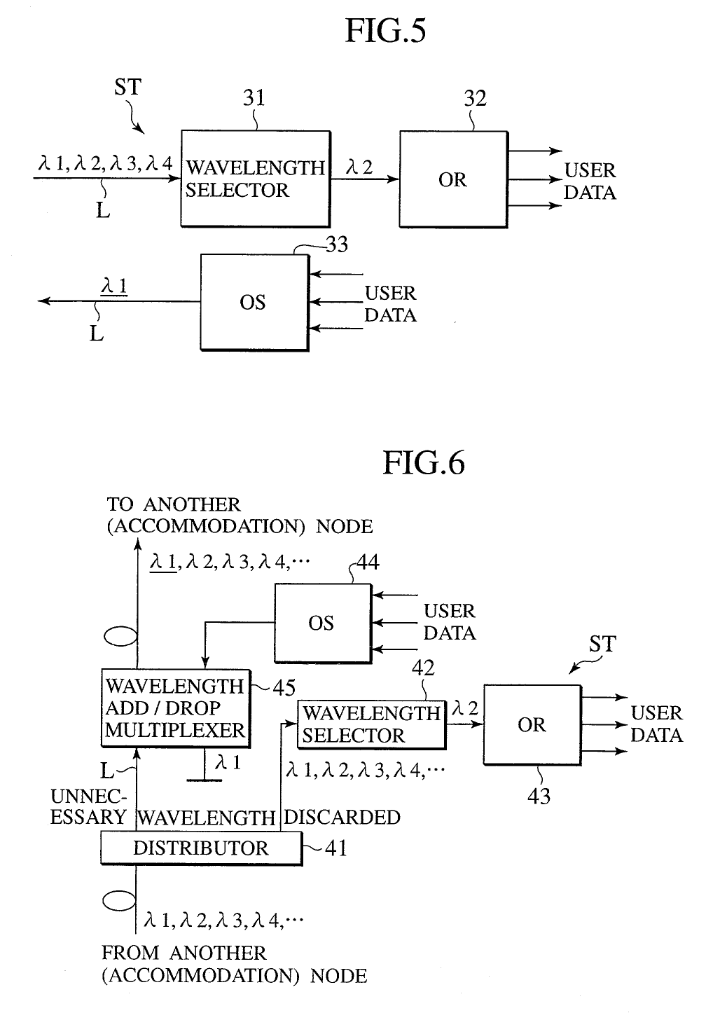

The connection node NC (a notation “NC” in which the suffix is omitted will be used to indicate a connection node in general, and the similar convention will also be used for the notation of the other elements hereafter), the accommodation node NM, and the stations ST (including a “dependent station” that is accommodated in the accommodation node NM and an “independent station” that is directly incorporated into the network loop) with such functions have configurations as shown in FIG. 3, FIG. 4, FIG. 5 and FIG. 6 respectively.

The connection node NC shown in FIG. 3 comprises: a demultiplexer 11 for demultiplexing optical signals circulating through the network into multiple wavelengths and discarding unnecessary wavelengths; a wavelength demultiplexer 12 for demultiplexing optical signals from another loop into signals of multiple wavelengths and discarding signals of unnecessary wavelengths; regenerative repeaters 13 to be provided according to the need (which will be omitted when they are unnecessary); a multiplexer 14 for multiplexing wavelengths to be passed and wavelengths to be newly loaded; and a distributor 15 provided at a next stage of this multiplexer 14. This distributor 15 distributes signals of prescribed wavelengths to the accommodated stations or another neighboring loop.

The accommodation node NM shown in FIG. 4 comprises: a wavelength add/drop multiplexer 21 for discarding one wavelength λ1 and loading signals of a prescribed wavelength λ1 from the accommodated dependent station ST with respect to the optical signals in wavelengths λ1, λ2, λ3, λ4, . . . that are circulating through the network; regenerative repeaters 22 to be provided according to the need, and a distributor 23 for distributing signals of the prescribed wavelength λ2 to the dependent station.

The dependent station ST that is accommodated in the accommodation node NM shown in FIG. 5 comprises: a wavelength selector 31 for selectively obtaining signals of a prescribed wavelength from signals of multiple wavelengths that are circulating through the network; an optical receiver (OR) 32; and an optical sender (OS) 33 for sending optical signals of a prescribed wavelength.

The independent station ST that is directly incorporated into the network loop comprises: a distributor 41 for distributing signals of multiple wavelengths that are circulating through the network; a wavelength selector 42 for selectively reading signals of a prescribed wavelength from signals of multiple wavelengths distributed by the distributor 41; an optical receiver (OR) 43, an optical sender (OS) 44 for sending optical signals of a prescribed wavelength; and a wavelength add/drop multiplexer 45 for loading signals of a prescribed wavelength from the optical sender 44 and discarding signals of prescribed wavelengths in order to avoid multiple circulations with respect to optical signals circulating through the network.

In this way, according to the first embodiment, the wavelength division multiplexing optical transmission scheme is adopted in the optical network and each station is allocated with its own wavelength, so that it becomes possible to transmit a large amount of data through the network and deliver desired data to a correspondent station, and therefore the limitations on the data transmission can be reduced.

Note that, by providing an optical amplifier at an interval of about several tens km and a regenerative repeater at an interval of several hundreds km on the network, it is possible to maintain a high signal quality and improve the reliability of the system. The same remark also applies to any of the embodiments to be described below. Note also that the optical amplifier or the regenerative repeater can be provided either directly on the network or within the station, the connection node or the accommodation node.

Next, the second embodiment of the broadcast type optical network system according to the present invention will be described.

This second embodiment has features that the same wavelength is allocated to a plurality of stations accommodated in the connection node or the accommodation node and the transmission data are multiplexed by the time division multiplexing in order to suppress the increase of the number of wavelengths used in the system.

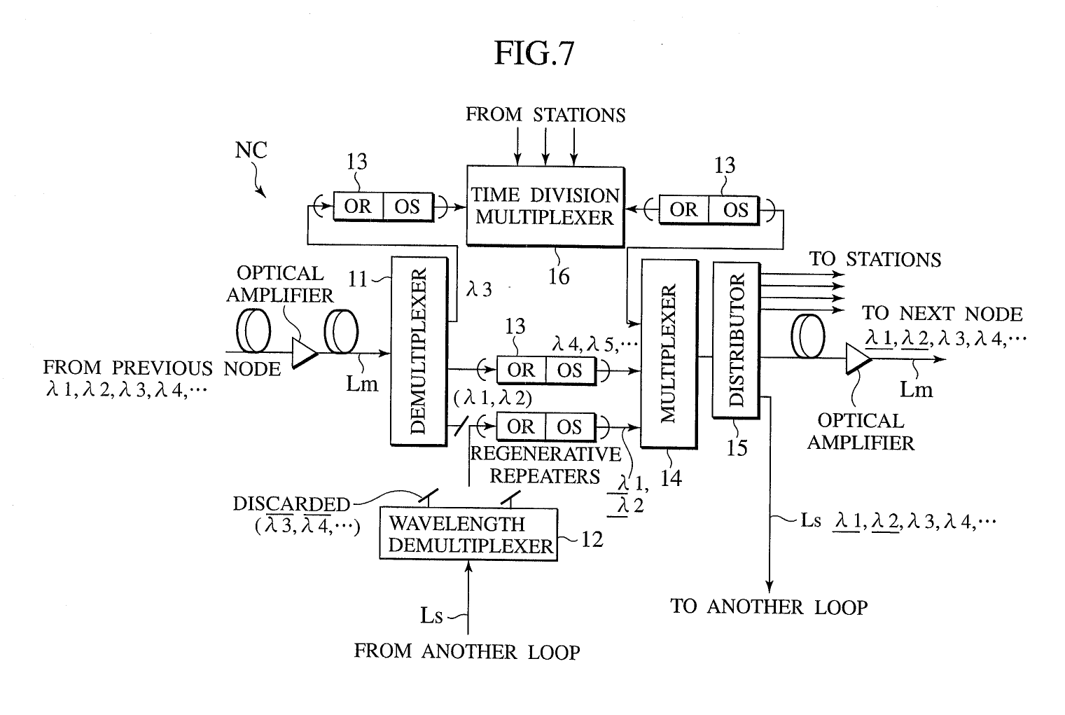

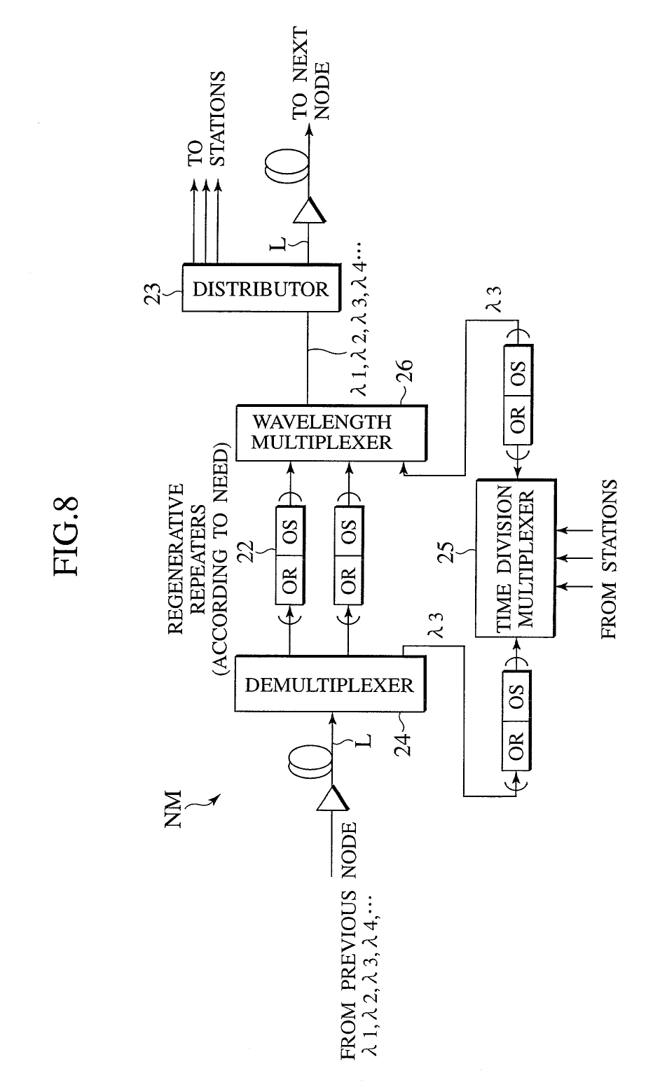

The overall configuration of the system according to the second embodiment is the same as that of the first embodiment shown in FIG. 1 and FIG. 2. in this embodiment, the connection node NC has a configuration as shown in FIG. 7, and the accommodation node NM has a configuration as shown in FIG. 8.

As shown in FIG. 7, the sub-loop Ls is connected to the main loop Lm by the connection node NC, and suppose that a plurality of stations ST are accommodated at the connection node NC. This connection node NC has the demultiplexer 11, the wavelength demultiplexer 12 with respect to the optical signals from the sub-loop Ls, the regenerative repeaters 13 to be provided according to the need, the multiplexer 14 and the distributor 15 similar to those of the first embodiment shown in FIG. 3, as well as a time division multiplexer 16 which is characteristic to this embodiment.

As shown in FIG. 8, a plurality of stations ST are accommodated at the accommodation node NM with respect to one loop L. This accommodation node NM also has the regenerative repeaters 22 and the distributor 23 similar to those of the first embodiment shown in FIG. 4, as well as a demultiplexer 24. a time division multiplexer 25 and a wavelength multiplexer 26 which is characteristic to this embodiment.

Each of these time division multiplexers 16 and 25 has a function of time division multiplexing data from a plurality of stations with respect to a wavelength (which is assumed to be λ3 here) received from the demultiplexer 11 or 21, converting them into the optical wavelength λ3 again, and supplying them to the multiplexer 23 as a wavelength λ3 onto which new data are loaded. Here, some time-slot of the time division multiplexing is allocated to each station, and new data will be overwritten on that time-slot.

Note that, in order to obtain data of each station data are time division multiplexed into the optical wavelength λ3 in this way at another station, at least a station that requires data from such a transmission station should be provided with a wavelength selector as well as a decoder compatible with the time division multiplexing.

In this way, it is possible to reduce the number of optical signal wavelengths used in the entire system.

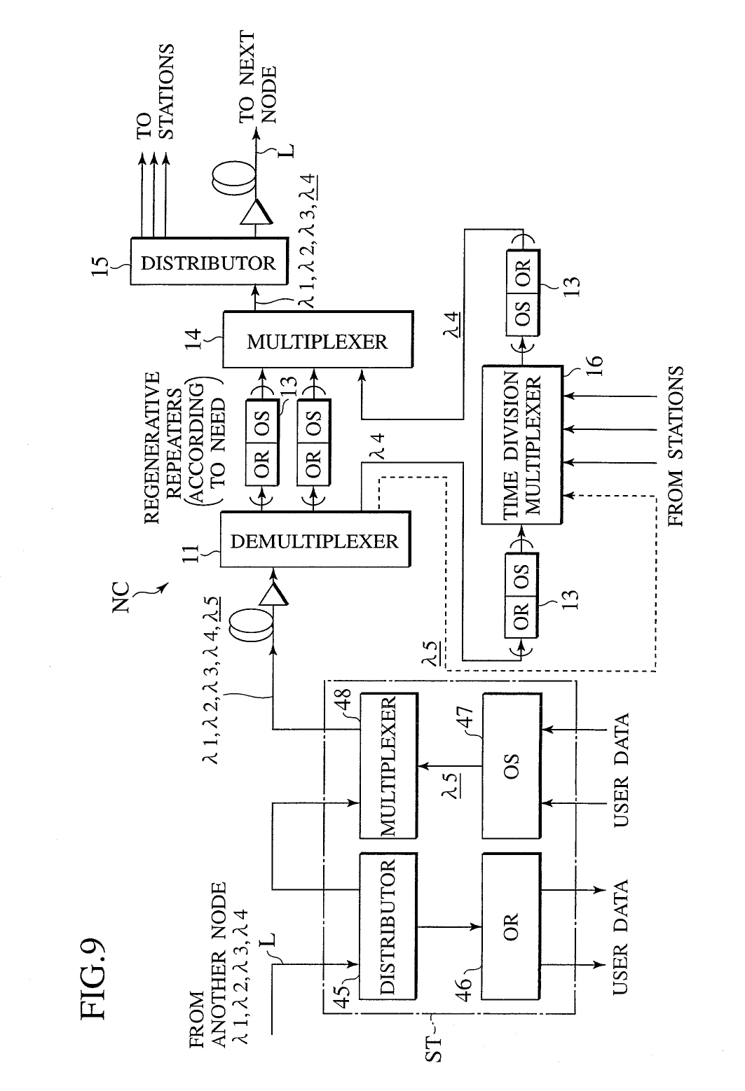

Next, the third embodiment of the broadcast type optical network system according to the present invention will be described with reference to FIG. 9.

This third embodiment has features that, when there is a nearby accommodation node NM or connection node NC as in the case of the independent station ST11 in the main loop L1 of the network system shown in FIG. 1, for example, an extra wavelength that does not overlap with wavelengths circulating through that loop is allocated to that station (here λ1 to λ4 are circulating and λ5 is allocated), and delivered from the nearby accommodation node or connection node by time division multiplexing it with wavelengths of the other stations accommodated at the nearby accommodation node or connection node.

In FIG. 9, suppose that the wavelengths λ1, λ2, λ3, λ4 are circulated through the loop L from the other nodes. The station ST obtains these wavelengths from a distributor 45 and receives data of the necessary wavelength at an optical receiver (OR) 46. Then, the transmission data are loaded onto a wavelength that is not circulated through the loop L (which is assumed to be λ5 here) at an optical sender (OS) 47, and it is multiplexed with the wavelengths λ1, λ2, λ3, λ4 on the loop at a multiplexer 48 and sent out to the loop L. Consequently, the connection node NC located nearby this station ST will receive wavelengths λ1, λ2, λ3, λ4, λ5.

At this connection node NC, the wavelength λ4 to be newly loaded at that node and the extra wavelength λ5 sent from the station ST are demultiplexed by the demultiplexer 11. Then, data sent by using this wavelength λ5 are received at the time division multiplexer 16, and data from a plurality of stations accommodated at the own node are newly loaded into one wavelength (which is assumed to be λ4 here) by the time division multiplexing, while data of the wavelength λ5 from the station ST mentioned above are converted into the wavelength λ4 here and loaded into the wavelength λ4 by the time division multiplexing. Then, this wavelength is multiplexed with the other wavelengths λ1, λ2 and λ3 at the multiplexer 14, and the wavelengths λ1, λ2, λ3 and λ4 are circulated through the subsequent section of the loop L.

In this way, when the time division multiplexing technique is employed, a single wavelength (which is assumed to be λ5) can be shared not only among the dependent stations but also among the independent station and the nearby dependent stations, so that the number of wavelengths required in the entire system can be reduced further.

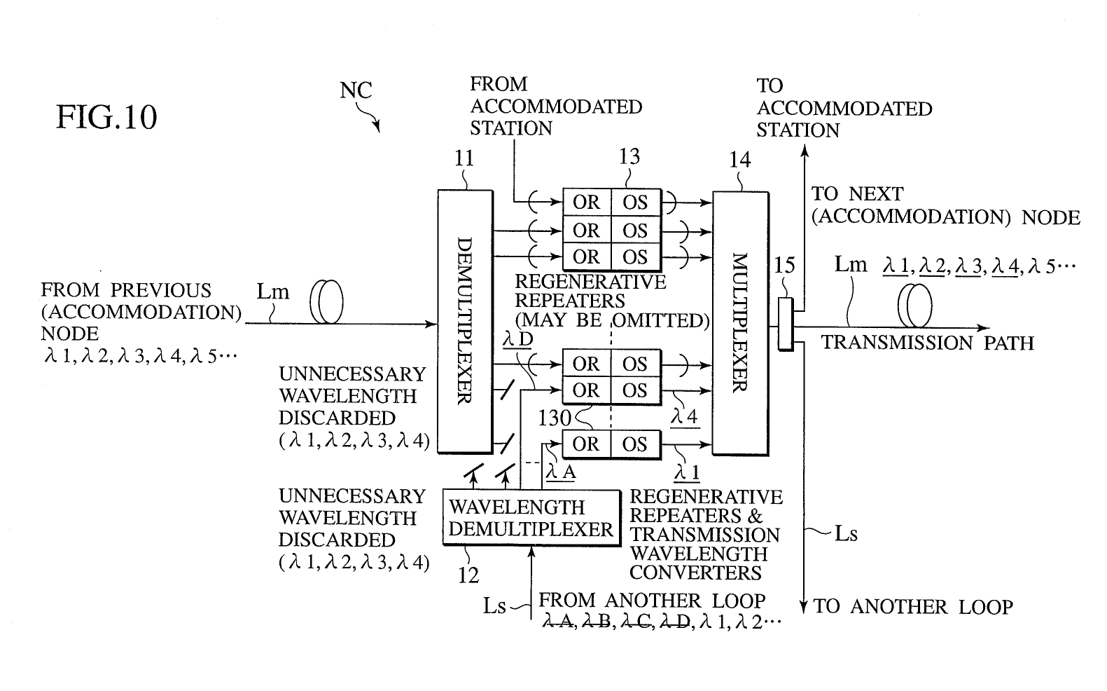

Next, the fourth embodiment of the broadcast type optical network system according to the present invention will be described with reference to FIG. 10 to FIG. 12.

This fourth embodiment has features that dedicated wavelengths are allocated within the loop in order to omit the wavelength add/drop multiplexer in the accommodation node NM, and these dedicated wavelengths are converted into formal wavelengths at a time of sending them out to the main loop at the connection node NC.

As shown in FIG. 10, the connection node NC for connecting the main loop Lm and the sub-loop Ls comprises the demultiplexer 11, the wavelength demultiplexer 12, the regenerative repeaters 13 to be provided according to the need, the multiplexer 14 and the distributor 15 similar to those of the first embodiment shown in FIG. 3, as well as regenerative repeaters and transmission wavelength converters 130 provided in correspondence to the sub-loop Ls that uses the dedicated wavelengths mentioned above.

These regenerative repeaters and transmission wavelength converters 130 convert the dedicated wavelengths (which are assumed to be λA to λD, for example) sent from the sub-loop Ls into prescribed wavelengths (which are assumed to be λ1 to λ4, for example) to be used for the circulation through the main loop Lm, while also carrying out the waveform shaping and the amplification according to the need.

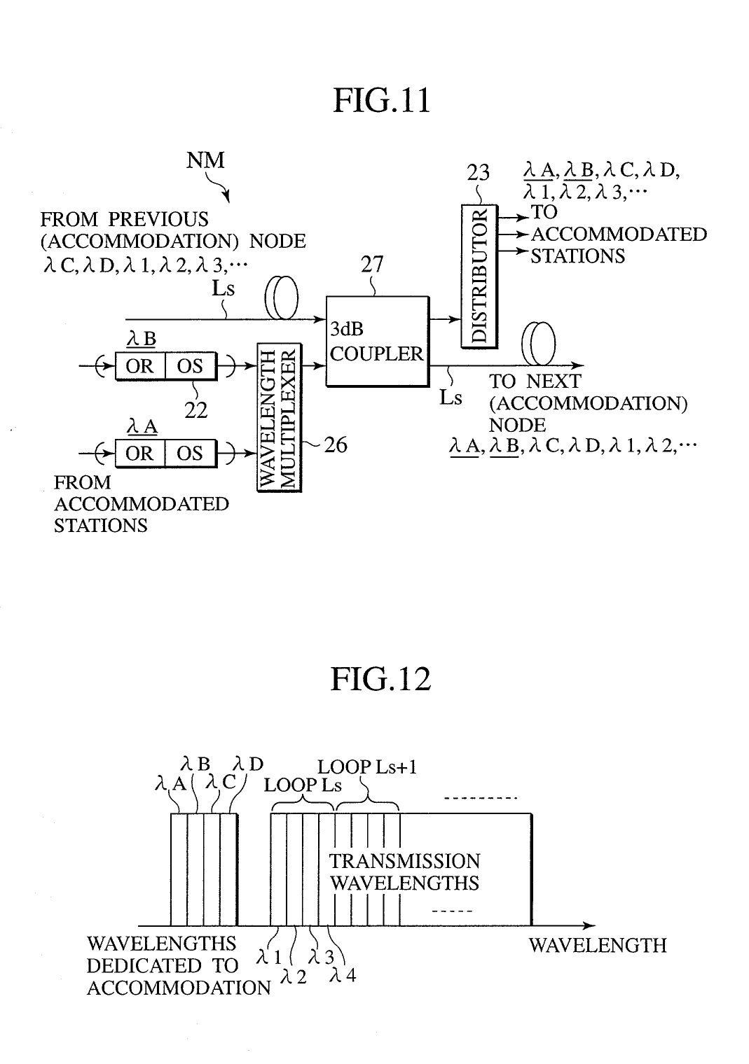

As shown in FIG. 11, the accommodation node NM on the sub-loop Ls that uses the dedicated wavelengths is provided with a wavelength multiplexer 26 and a 3dB coupler 27, while omitting the wavelength add/drop multiplexer used in the accommodation node of the first embodiment shown in FIG. 4.

The accommodation node NM on the sub-loop Ls has the following functions. Suppose that the wavelength bandwidth λA to λD that are not used in the main loop Lm is allocated to the sub-loop Ls, and two wavelengths λA and λB are allocated to the accommodation node NM shown in FIG. 11 and these wavelengths λA and λB are allocated to stations ST accommodated at this accommodation node NM.

At the accommodation node NM, the signal wavelengths λA and λB (with new data loaded) from the respective stations are wavelength multiplexed by the wavelength multiplexer 26, multiplexed with the wavelengths λC, λD, λ1, λ2, λ3, . . . from the previous node at the 3dB coupler 27, and sent out to the next node.

At the connection node NC for connecting the sub-loop Ls to the main loop Lm, as shown in FIG. 10, the dedicated wavelengths λA, λB, λC and λD are extracted from the wavelengths λA, λB, λC, λD, λA, λ2, . . . that are eventually sent from the sub-loop Ls, these wavelengths are converted into the transmission wavelengths λ1, λ2, λ3 and λ4 by the regenerative repeaters and transmission wavelength converters 130, and these converted wavelengths are multiplexed with the other wavelengths λ5, λ6 , . . . as wavelengths λ1, λ2, λ3 and λ4 that are newly loaded from the sub-loop Ls and sent out to the next node by the multiplexer 14.

In this way, in the optical network system in which a plurality of sub-loops Ls, Ls+1, . . . are connected to the main loop Lm, as shown in FIG. 12, it becomes possible to allocate the common wavelengths to these sub-loops as wavelengths dedicated to accommodation, so that the wavelength add/drop multiplexer becomes unnecessary and the system cost can be reduced.

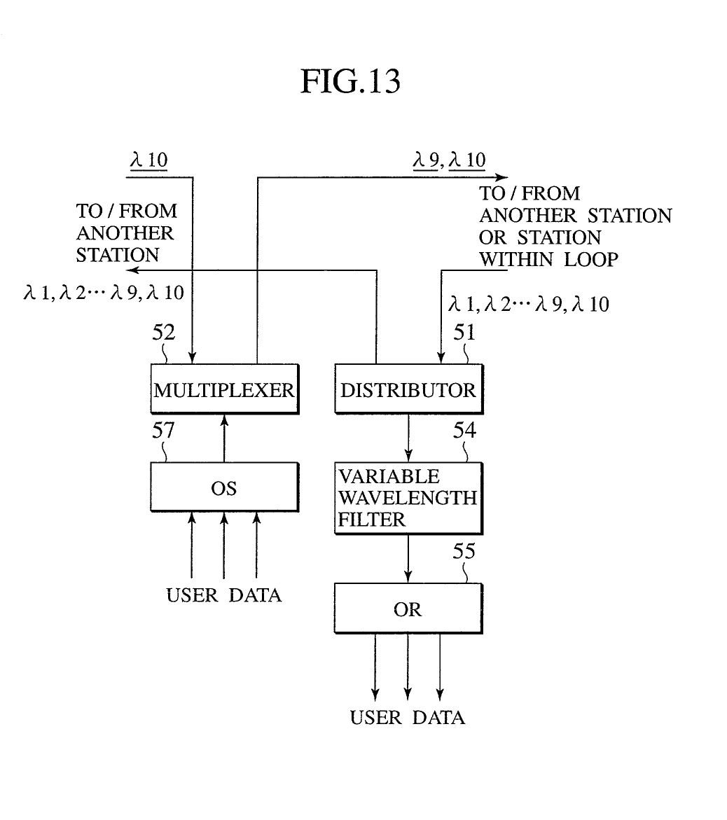

Next, the fifth embodiment of the broadcast type optical network system according to the present invention will be described with reference to FIG. 13.

This fifth embodiment is directed to the transmission and reception of optical signals with respect to a child station that is connected only with a parent station, such as a child station ST113-1 that is connected only with a parent station ST113 in FIG. 1.

As shown in FIG. 13, the parent station 113 has a distributor 51, a multiplexer 52, a variable wavelength filter (wavelength selector) 54, an optical receiver (OR) 55, and an optical sender (OS) 57.

Here, this parent station ST113 distributes the wavelengths λ1, λ2, λ3, . . . , λ9. λ10, λ11, . . . that are sent from the accommodation node NM to the child node ST113-1 while receiving them at the own station, by the distributor 51. Then, within the own station, data of the necessary wavelengths are selectively extracted by a variable wavelength filter (wavelength filter) 54. The data to be transmitted from the own station are loaded into a wavelength λ9 (which will be denoted as a wavelength λ9).

The child station ST113-1 has a configuration similar to that of the parent station ST113 shown in FIG. 13 except that the distributor 51 and the multiplexer 52 are omitted, and receives the wavelengths λ1, λ2, λ3, . . . , λ9, λ10, λ11, . . . sent from the accommodation node NM via the distributor 51 of the parent station ST113. Then, within the own station, data of the necessary wavelengths are selectively extracted by the variable wavelength filter (wavelength selector) 54. The data to be transmitted from the own station are loaded into a wavelength 10 (which will be denoted as a wavelength λ10), and this wavelength λ10is sent to the parent station ST113. In other words, the child station ST113-1 has the configuration substantially similar to that shown in FIG. 5.

Then, at the parent station ST113, the wavelength λ9 of the own station is multiplexed with the wavelength λ10 from the child station ST113-1 by the multiplexer 52, and the wavelengths λ9 and λ10 are sent out to the accommodation node NM.

In this way, when there is a station that is not so important as it is geographically distant from the loop, and it is preferable to connect this station to a nearby station rather than connecting it to the accommodation node in view of the cost, it is possible to save the cost by adopting the configurations of this fifth embodiment.

As described, the broadcast type optical network system of the present invention is formed by at least one loop shaped optical network in which any one of a plurality of stations provided in the network is capable of carrying out unidirectional communications with respect to all the other stations provided in the network. At least one wavelength is allocated to each station such that each station can transmit data by using the allocated wavelength, receive data of any wavelengths transmitted from any other stations, and select only necessary wavelengths so as to select correspondent stations from which data are to be received. In addition, each station has a function for loading or re-loading wavelengths, as well as a function for discarding signals of the wavelength transmitted from the own station that has circulated through the network in order to prevent multiple circulations of signals of the wavelength transmitted from the own station. Consequently, each station can transmit data by using the wavelength allocated to the own station any time according to the need.

In addition, it is possible to adopt the wavelength division multiplexing scheme for the signal transmission scheme, so that it is possible to reduce the number of cores in the optical fiber to be used as a transmission path, so that the system cost can be reduced.

Moreover, when a plurality of loop shaped networks are used, a connection node for transferring signals from one network to another network is provided between neighboring networks, so that it is possible to connect a plurality of networks and transmit data by using the allocated wavelength from any one station to any other stations.

Furthermore, an accommodation node is provided at arbitrary loop shaped network, and a plurality of stations are connected to this accommodation node such that each station transmits data to the loop shaped network and receive data from the other stations, through the accommodation node, so that it is possible to transmit data from arbitrary station to any other stations by using the wavelength unique to that station.

Also, when a main loop network and a neighboring sub-loop network are used, an identical wavelength can be allocated to a plurality of stations provided in the sub-loop network and data can be transmitted by the time division multiplexing transmission scheme, so that the number of wavelengths can be reduced.

Also, when a main loop network and neighboring sub-loop networks are used, a plurality of different wavelengths can be allocated to a plurality of stations provided in each sub-loop network and these wavelengths can be converted into wavelengths used in the main loop at the connection code for connecting the main loop network and that sub-loop network, so that identical wavelengths can be used for a plurality of sub-loops and the number of wavelengths required in the system can be reduced.

In addition, the signals can be transmitted to a multiplexer of the neighboring connection node or accommodation node by using a vacant wavelength channel on the network, so that the number of wavelengths to be allocated to the stations can be reduced and the wavelengths can be saved as much.

In addition, the regenerative repeaters can be provided on the loop shaped network at an interval of about several hundreds km such that the network can be formed over a geographically wide area while realizing a high quality data transmission.

It is to be noted that the embodiments described above are directed to simplified cases for the sake of explanation, and can be modified by suitably changing the number of wavelengths, the number of loops, the number of stations, the number of nodes, and the system layout.

It is also to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. A broadcast type optical network system, comprising:
at least one loop shaped optical network; and
a plurality of stations provided on the at least one loop shaped optical network;
wherein at least one wavelength is allocated to each station such that each station can transmit data by using a wavelength allocated to said each station, receive data of any wavelengths transmitted from any other stations, and select only necessary wavelengths so as to select correspondent stations from which data are to be received, and
each station has a function for loading or re-loading wavelengths, and a function for discarding signals of one wavelength transmitted from said each station that has circulated through the at least one loop shaped network in order to prevent multiple circulations of the signals of said one wavelength;
such that any one of the plurality of stations is capable of carrying out unidirectional communications with respect to any other one of the plurality of stations.

2. The broadcast type optical network system of claim 1, wherein a wavelength division multiplexing scheme is adopted for a signal transmission scheme through the at least one loop shaped optical network.

3. The broadcast type optical network system of claim 1, wherein the at least one loop shaped optical network includes a plurality of loop shaped optical networks, and the broadcast type optical network system further comprises:
a connection node for transferring signals from one network to another network, that is provided between neighboring ones of the plurality of loop shaped optical networks.

4. The broadcast type optical network system of claim 3, wherein a group of stations are connected to the connection node such that each one of the group of stations transmits data to the at least one loop shaped optical network and receive data from any other stations provided in the at least one loop shaped optical network, through the connection node.

5. The broadcast type optical network system of claim 4, wherein an identical wavelength is allocated to the group of stations connected to the connection node, and the connection node transmits data transmitted by the group of stations to the at least one loop shaped optical network by using a time division multiplexing scheme.

6. The broadcast type optical network system of claim 3, an independent station that is provided directly in the at least one loop shaped optical network transmits data to the connection node that is located nearby the independent station by using a vacant wavelength on the at least one loop shaped network.

7. The broadcast type optical network system of claim 6, wherein a group of stations are connected to the connection node such that each one of the group of stations transmits data to the at least one loop shaped optical network and receive data from any other stations provided in the at least one loop shaped optical network, through the connection node, an identical wavelength is allocated to the group of stations connected to the connection node, and the connection node transmits data transmitted by the group of stations and the independent station to the at least one loop shaped optical network by using a time division multiplexing scheme.

8. The broadcast type optical network system of claim 3, wherein the at least one loop shaped optical network includes a main loop network and neighboring sub-loop networks, the connection node is provided between the main loop network and each neighboring sub-loop network, a plurality of different wavelengths are allocated to more than one stations provided in each neighboring sub-loop network, and the plurality of different wavelengths are converted into wavelengths used in the main loop at the connection node.

9. The broadcast type optical network system of claim 1, further comprising:
an accommodation node, that is provided in the at least one loop shaped optical network, to which a group of stations are connected such that each one of the group of stations transmits data to the at least one loop shaped optical network and receive data from any other stations provided in the at least one loop shaped optical network, through the accommodation node.

10. The broadcast type optical network system of claim 9, wherein an identical wavelength is allocated to the group of stations connected to the accommodation node, and the accommodation node transmits data transmitted by the group of stations to the at least one loop shaped optical network by using a time division multiplexing scheme.

11. The broadcast type optical network system of claim 9, an independent station that is provided directly in the at least one loop shaped optical network transmits data to the accommodation node that is located nearby the independent station by using a vacant wavelength on the at least one loop shaped network.

12. The broadcast type optical network system of claim 11, wherein an identical wavelength is allocated to the group of stations connected to the accommodation node, and the accommodation node transmits data transmitted by the group of stations and the independent station to the at least one loop shaped optical network by using a time division multiplexing scheme.

13. The broadcast type optical network system of claim 1, wherein the plurality of stations includes a parent station and a child station that is connected only to the parent station, and the child station transmits/receives data to/from the at least one loop shaped optical network through the parent station.

14. The broadcast type optical network system of claim 1, further comprising regenerative repeaters provided on the at least one loop shaped optical network at a prescribed interval.
